(19) United States
(12) Patent Application Publication
(10) Pub. No.: US 2010/0235304 A1
(43) Pub. Date: Sep. 16, 2010

(54) Electricity use system in electric vehicles

(76) Inventor: Thomas J. Mikos, Cape Coral, FL (US)

Correspondence Address: Thomas J. Mikos, P.O. Box 60944, Fort Myers, FL, 33906, US

(21) Appl. No.: 12/381,537

(22) Filed: Mar. 13, 2009

(51) Int. Cl. G06F 17/00

(52) U.S. Cl. 705/412

(57) ABSTRACT

The inventive concept is directed to a method of collecting highway user taxes from the use of an electric vehicle. The invention includes the steps of placing a revenue meter next to a regular meter. The revenue meter only records the amount of wattage being used to charge or recharge the battery in the electric vehicle. This is accomplished by using the revenue meter to relay a current of 110V AC to the vehicle. The vehicle has a computer that will divert the high voltage to a current inverter which inverts the high voltage to a low voltage prevalent in the vehicle. The low voltage is also converted to a DC current which is instrumental in recharging the battery. The computer will also signal to the revenue meter when the respective battery is fully charged. The revenue meter will be read by a meter reading person together with the main meter. The invoice conveyed to the customer will record the regular charges that were incurred through the use of electricity but will also have an added charge indicative of the prevailing highway use taxes. The power company would convey the thus collected taxes to the respective authorities.

### BACKGROUND OF THE INVENTION

It has been considered to tax motorists based on how many miles driven. Gasoline taxes have been charged on the gasoline consumed by monitoring the gasoline fuel that is put into the tank of a vehicle at all the gasoline stations. It is clear that these taxes are used to maintain the federal as well as the state highway system. This program that funds the federal share of highway projects is part of a surface transportation law that may soon expire. Congress has made an emergency infusion to make up for a shortfall between gas tax revenues and the amount of money promised to the states for their projects. The gap between the money raised by gas tax and the cost of maintaining the nation's highway system and expanding it to accommodate projected population growth is forecast to continue to widen.

Among the reasons for the widening gap is a switch to more fuel-efficient cars and a decrease in driving that many transportation experts believe is related to an economic downturn.

In addition the growing use of hybrid cars results in less gasoline being used resulting in a decrease in tax revenue.

Furthermore, a construction of total electric cars is being pursued. Theses electric vehicles will also use the federal highway system without contributing to its maintenance because no highway taxes are being collected because no gasoline is being purchased which would be the only avenue to get hold of any tax contribution.

It is being foreseen that the use of electric vehicles will increase based on research and many other advances being made. It is also foreseen that a research in batteries will greatly contribute to more powerful and longer lasting batteries that could be instrumental in greatly increasing the distance electric vehicles will be able to travel to thereby greatly increase the use of the federal and/or state highway system without contributing to its cost of building and maintaining the system.

The suggestion that the administration consider taxing motorists based on how many miles are being driven instead of how much gasoline is bought is extremely cumbersome and expensive. A proposal has been considered to place GPS chips in vehicles to charge motorists by the mile has drawn considerable objections because of an almost insurmountable record keeping but importantly it eliminates an incentive to drive fuel efficient cars since gas guzzlers will be taxed at the same rate as fuel sippers.

### BRIEF DESCRIPTION OF THE INVENTION

The inventive concept takes an entirely different approach to the task of collecting highway taxes even though no gasoline is being bought through the use of electric cars. By using electric cars, the batteries will be charged, when necessary, by the owners or users of the vehicle at either their residence or by commercial establishments that use a fleet of cars at the location where those vehicles are garaged. It is clear that the electric vehicle has a current converter that will convert the 110V electric current to the voltage of a particular vehicle and at the same time convert the AC current to a DC current. It is foreseen that a revenue meter will be installed as an adjunct to an already present meter at a residence or a commercial establishment. This adjunct or revenue meter will only record the wattage used to recharge an electric vehicle. Of course certain codes are required to identify that the adjunct meter use is only used to recharge an electric vehicle. A meter reader person will record the wattage used of both meters and the customer will be charged accordingly. The Power Company would forward the tax charged as an excess of the wattage used in the adjunct or revenue meter to the respective administrative entities. This requirement of the codes and how they operate will be explained below.

### BRIEF DESCRIPTION OF THE DRAWINGS

FIG. 1 shows a revenue or adjunct meter with its connections to a wall;

FIG. 2 shows the receptacle on a wall and the wiring associated therewith;

FIG. 2A is a representation of the end plug of a power cord.

FIG. 3 shows plug ends in conjunction with the various outlets;

FIG. 3A shows the plug ends of a power cord.

FIG. 4 shows the receptacle on the electric vehicle;

FIG. 5 illustrates the electric components on the electric car.

### DETAILED DESCRIPTION OF THE INVENTION

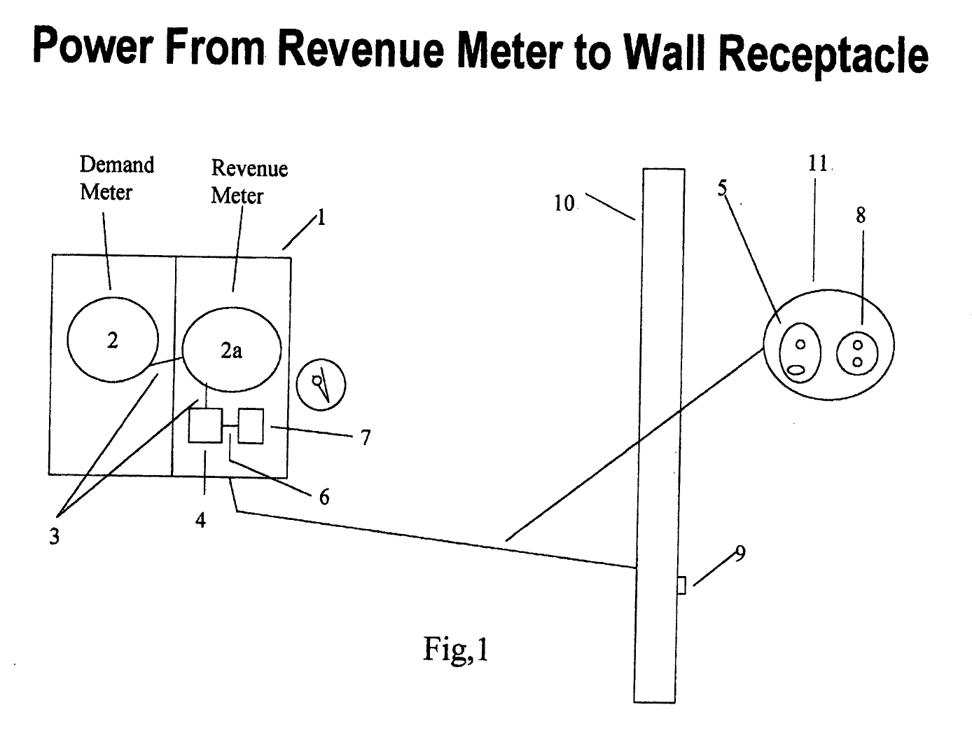

FIG. 1 shows the origin of the electric power that is transferred to the electric vehicle wherein the main or conventional meter 2 provides power to the revenue or adjunct meter 2a and the power flow is shown by the line 3. Providing power to the revenue meter 2 which will record the power used in charging the electric vehicle. The 100V AC current flows from the revenue meter to a controller switch 4. The controller switch 4 is opened and closed by the fueling or recharging controller switch 7. The fueling controller switch is activated by the vehicle computer 35 which operates the fueling or charging process.

When the controller switch 4 is opened, it activates the controller switch 4 to open and 100V AC power 5 flows to the vehicle being charged. Power in the low voltage line 8 originates from the vehicle's computer 35 to the fueling controller switch 7. After the vehicle computer 35 confirms the authorization codes, the fueling begins. The power company will read the revenue meter 2a in the same manner as the conventional demand meter 2 is read. Power consumed by the revenue meter will be billed to the customer and appropriate road taxes will be applied and distributed to the various taxing authorities.

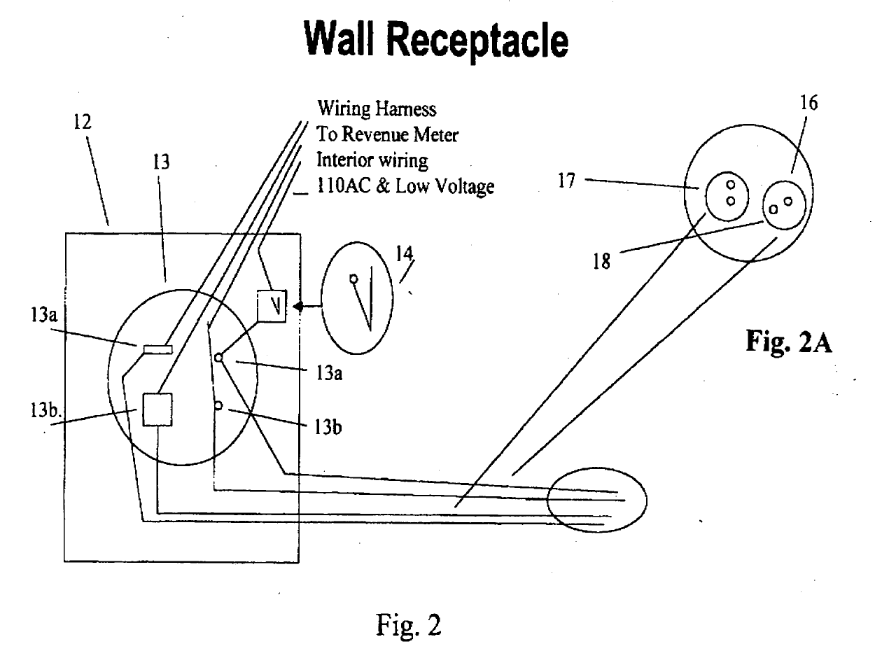

FIG. 2 illustrates the wall 9 (FIG. 1). The wall receptacle 9 is shown in an enclosure 12. There is also shown a front view of a plug configuration 13. As mentioned above, the receptacle 9 (FIG. 1) transfers both the 110v AC voltage and the low voltage. At the left side of the plug configuration 13 there are shown the contact points 13a and 13b. On the right side of the plug configurations are shown contact points 13c and 13d for low voltage transmission. The four conductors of the wire harness 11 above the plug configuration 13 lead to the revenue meter 2a. The wall wiring harness 11 is concealed within the wall 10 according to prevailing building codes.

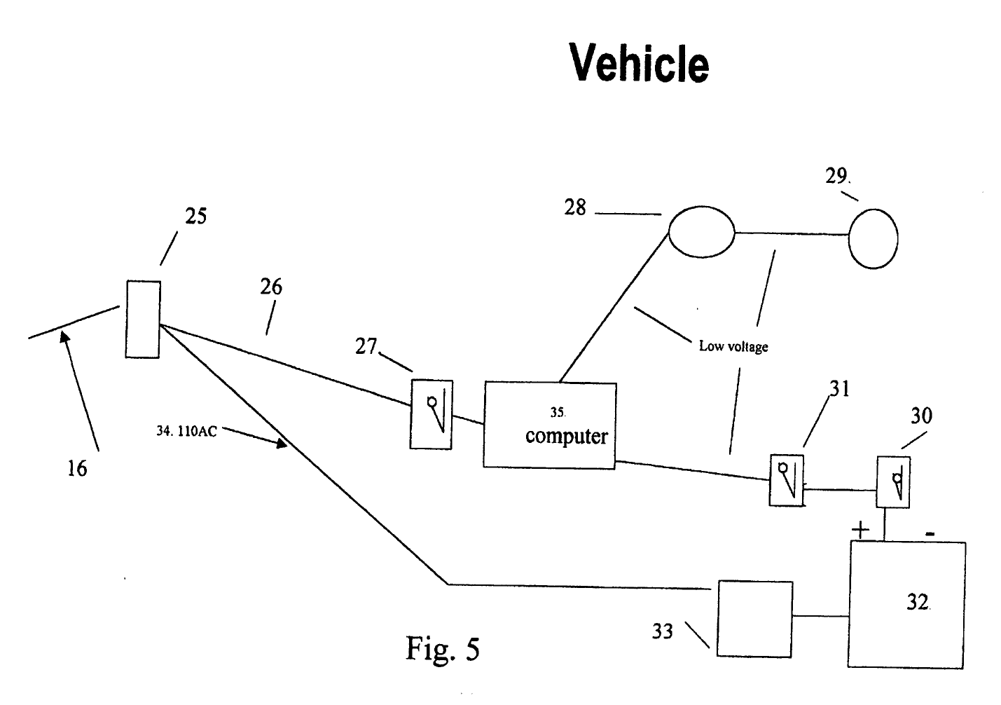

There is fueling or charging switch 14 located in the wall receptacle. This controller or switch 14 is made a part of the wall receptacle and is tamperproof. This controller switch 14 must be recognized by the computer 35 to authorize charging and close when this process is completed. Contact points 13a, 13b, 13c and 13d are male pins which will insert into plug ends 20a. The lower four lines depicted in FIG. 2 represent a power cord 16 which will plug into the wall receptacle 16 (FIG. 2) and the vehicle receptacle 25 in FIG. 5.

FIG. 2A illustrates a cross section of the power cord 16 that is attached to identical male plug ends. The cord is a four conductor cable with plug ends 17 and 18 molded into the cord.

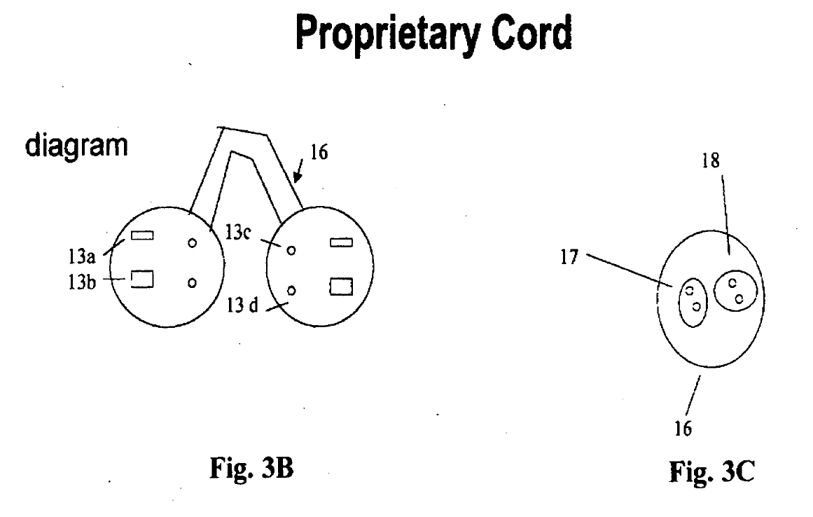

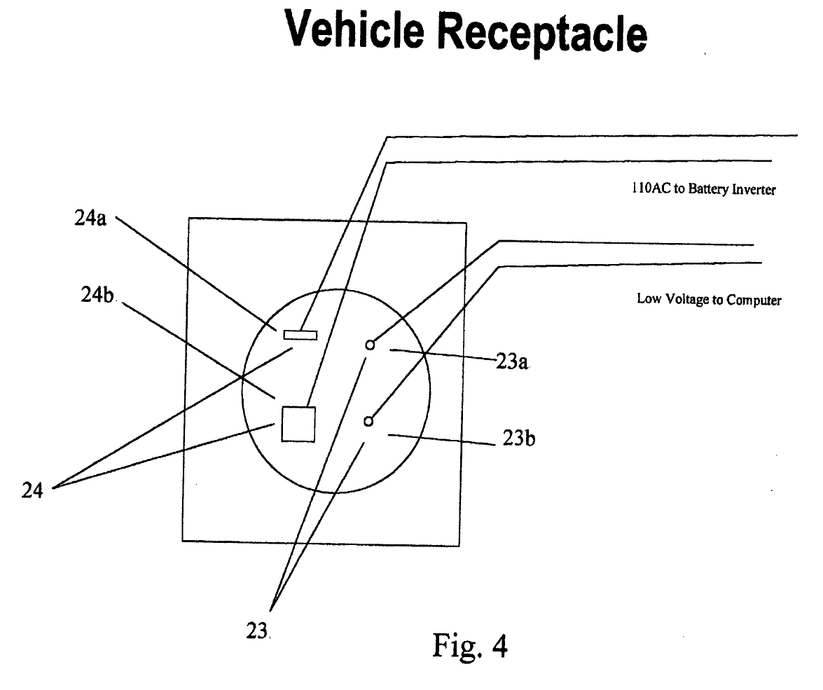

FIG. 3 represents the molded plug configuration 19, wherein 22 represents the 110V AC and 21 represents the low voltage contacts 12V DC. These contacts are female and receive the contact pins 13a, 13b, 13c and 13d and 24a, 24b, 24 c and 24d, respectively, in the receptacles (FIGS. 2 and 4). The 110V AC flows to the battery inverter 33. The low voltage 12V DC flows to the computer 35 through the controller 27 in FIG. 5, which then opens or closes the controllers located in the wall receptacle (FIG. 2) and the revenue meter control switch 27 (FIG. 5).

FIG. 3B represents the power cord 20 depicting the contact configurations and the four conductor power cord end 20a.

FIG. 4 The vehicle receptacle is an assembly line part and is provided when the vehicle is purchased. It is a specially designed receptacle having the pins 24a and 24b to receive high voltage of 110 V AC and pins 23a and 23b will receive low voltage of 12V which is a feed back to the revenue meter.

FIG. 5 illustrates the electric vehicle charging system. On the left side of the illustration there is shown the charging cord 16. It connects the wall receptacle FIG. 2 to the vehicle receptacle in FIG. 4. Internal wiring is provided to connect the wall receptacle in FIG. 2 to the inverter 33. The wiring is a two conductor wire 34 of a predetermined gauge to handle the prevailing amperage. Through the inverter 33 the voltage is changed to a low DC voltage requirements of the particular vehicle involved. The manufacturers will determine the low voltage requirements of the vehicle operating system except for the low communicating system 26. The communicating system 26 will be an industry standard

### Operation

The operator of the vehicle observes the status gauge 29 to determine if a recharge is needed. If a recharge is required, the operator rotates the ignition key 28 which will start the charge process. With the key in a charge position, a signal is sent to the computer 35 to allow charging to begin. The computer 35 opens the controller 27. The sensor 30 monitors the status of the battery. When the charging process begins, the computer 35 signals the controller 27 to open and the microprocessors 14, 7 and 4. The revenue meter 2a is open to allow the 110V AC current to flow through he the open system to charge the battery. When the sensor 30 determine a fill charge, the shutdown process begins.

What I claim is:

1. A method of collecting highway use taxes from electric vehicles comprising the steps of adding a revenue meter to an already existing regular meter, recording on said revenue meter only charges that are incurred when charging a battery of said electric vehicle, including the step of monitoring the amount of wattage being used and signaling the revenue meter to stop charging when a fully charged battery is sensed.

2. The method of claim 1 including installing a computer in the manufacture of said electric vehicle and coding said computer to recognize only a vehicle battery to be charged while excluding all other uses of said revenue meter.

3. The method of claim 1 including the use of a power cord that will carry both a high voltage to said vehicle and returning a low wattage signal back to said revenue meter.

4. The method of claim 1 including an installation of an Amp meter in said electric vehicle.
